(19) United States
(12) Patent Application Publication
(10) Pub. No.: US 2007/0050072 A1
(43) Pub. Date: Mar. 1, 2007

(54) Blank for a dental prosthetic item containing machining information, machining device therefor, and machining method therefor

(76) Inventor: Axel Schwotzer, Gross-Gerau (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/512,343

(22) Filed: Aug. 30, 2006

Related U.S. Application Data
(60) Provisional application No. 60/752,901, filed on Dec. 23, 2005.

(30) Foreign Application Priority Data
Sep. 1, 2005 (DE) 10 2005 041 693.4

(51) Int. Cl. G06F 19/00

(52) U.S. Cl. 700/116; 700/118

(57) ABSTRACT

A blank (10) for the production of a dental prosthetic item (22) by being machined is provided with information relevant to the machining operation by an information-containing memory (22) which is connected to the blank (10) and readable by radio signals. A machining device for the production of dental prosthetic items from the blank (10) includes a reading device (16) for obtaining information concerning the blank (10) by means of radio signals (23). A method of machining such a blank is disclosed.

### CROSS-REFERENCE TO RELATED APPLICATION

This application is based on U.S. Provisional Application No. 60/752,901, filed Dec. 23, 2005, the priority of which is hereby claimed, as well as German Patent Application 10 2005 041 693.4, filed Sep. 1, 2005, the priority of which is also claimed.

### TECHNICAL FIELD

The invention relates to a blank for a dental prosthetic item, which blank contains information that is relevant to machining thereof. The invention also relates to a machining device for such a blank and to a method of machining such a blank.

In the machining of blanks in the form of partially cured ceramic blocks which undergo a sintering process after being machined in order to acquire their final strength, the blanks must be produced larger than the finished item because they shrink during the sintering process. The shrinkage parameters of a dental ceramic, for example, generally depend on the batch from which the blanks were formed.

Furthermore, blanks exhibit different material properties such as color, translucency, or external shape, which need to be taken into account when they are machined.

### DESCRIPTION OF THE RELATED ART

It is known from the prior art to read bar coded shrinkage data using a conventional barcode reader, as described in WO 99/47065 A1 for example.

The shrinkage parameters are placed on the ceramic block itself or on the stub by printing a barcode thereon. These shrinkage parameters are made accessible before the machining process for computation of the semifinished part that is to be produced by material removal.

It is further known from EP 1 106 146 A1 to enter the data into an electronic computing and controlling unit for a machining device using a reading device.

WO 01/97797 A1 describes a device which combines machining of a workpiece, 3D scanning of a model, and reading of a barcode identifier on the workpiece in a single device, though at different locations and by different means. The machining device can modify or remove the information during the machining process. But here again a source of error still remains due to the fact that the blank, after its barcode identifier has been read, may be replaced by another, perhaps because it was put aside for a while before being fixed in the chuck.

Besides barcode technology, the automatic identification technology sector has also witnessed the development of RFID, according to which a transponder is placed on the object to be identified, and the data contained in the transponder are recorded by a data collecting device by means of radio waves or magnetic induction. This kind of transponder can be realized as an adhesive label or can be designed to be pushed into a body or included therein by casting.

It is an object of the invention to provide a blank, a machining device, and a method which further reduce the risk of errors in identifying the coded workpiece.

### SUMMARY OF THE INVENTION

This object is achieved by using a blank which includes a readable memory thereon which contains information relevant to the machining process and which is located on the blank so as to be read by radio signals.

The blank of the invention for the production of a dental prosthetic item by a process for machining the blank provided with information relevant to the machining has a readable memory connected thereto, which memory contains the information. The memory is designed and configured on the blank such that the information is readable via radio signals.

The advantage of radio signals over a barcode is that no direct visual contact is required, so that the memory can be disposed at locations of the blank that are concealed from view, if desired. Accordingly, the memory comprises means for receiving radio signals and for sending radio signals, and it can draw its energy from the radio signals thus received.

It is advantageous when the information stored in the memory is also modifiable by means of radio signals. In this way it is possible to document states of machining progress.

For example, the machining procedure, particularly the tools used, the machining rate, the speed of rotation, the time of day, the identification of the grinding machine, and/or the identification of the stub can be stored so that if machining is interrupted before the actual end of the operation, the progress thereof is documented.

Specifically, for a blank from which several dental prosthetic items are to be produced in succession, the status can be documented in such a way that further automated machining of a blank which has already been partly machined is possible.

Parameters which are relevant to sintering in a kiln may be stored in memory and read, before the sintering process begins, by a reading device located in the kiln.

According to a development of the invention, the blank has a stub for securing it in machining device, and the memory is attached to the stub. This can ensure that machining of the blank will not lead to the loss of the memory.

It is advantageous when the blank comprises a corpus from which the dental prosthetic item is carved and to which the memory is affixed. The advantage of this is that the memory can be attached during the process of producing the blank corpus, and the information from this process can be deposited directly in the blank corpus. It is impossible to allocate the wrong blank corpus to the stub.

When the blank consists of a stub and a corpus, it is alternatively possible for the memory to be disposed in a connecting layer present between the corpus and stub. This ensures a robust memory in relation to environmental influences such as moisture.

According to a development of the invention, the memory is included in the stub, which is at least partially permeable to radio signals. This again ensures robustness.

According to a further development, the memory is enclosed in a glass tube or a self-adhesive label.

According to another development, an information bit in the memory takes the form of a signal value of a sensor that is disposed in the immediate proximity of the memory, which signal value is capable of being queried via the memory by means of radio signals. In this way it is possible, for example, to measure the temperature of the blank before and/or during the machining process, and to take the necessary steps to adjust the temperature or to adapt the grinding schedule to temperature deviations.

The memory can alternatively be disposed on the blank stub as long as it is guaranteed that the identifier is recognizable in the clamped condition. The blank is thus identified in the chuck in which it is about to be machined.

The invention further relates to a machining device for producing dental prosthetic items from a blank, which device comprises a chuck for the accommodation of the blank. Information concerning the blank is available on the blank itself or on the stub. A reading device is also provided for reading a memory containing the information by means of radio signals.

The advantage of this is that the information concerning the blank can be acquired immediately prior to machining without the blank being changed thereafter, i.e., without the blank being removed from the chuck device. Mistakes in the allocation of blank information can be reliably avoided in this way.

Appreciable advantages can be gained particularly by controlling the machining device on the basis of the information contained in the identifier. For instance, the forward feed rate can be adjusted on the basis of the material selected, or, when designing, allowance can be made for minimum wall thicknesses depending on the strength of the material.

It is advantageous when the reading device additionally has a write function so that information stored in the memory can be modified via radio signals.

According to a further development of the invention, software is provided for producing the dental prosthetic item, which software is designed such that the information received via radio signals is allowed for during computation of the dental prosthetic item to be produced and/or when controlling the machining device and/or when used for documentation purposes.

Documentation encompasses not only storing the information but also holding it ready for further processing such as billing, quality assurance, and so on.

It is advantageous when the reading device is disposed in relation to the blank chuck such that the information concerning the blank held in the chuck presents the strongest radio signal compared with blank not in the chuck.

Furthermore, it is also advantageous when the distance of the reading device from the blank chuck is shorter than the distance of the blank from an exterior housing of the machining device. This prevents blanks outside the machining device from being included in the memory readout.

It is advantageous when the range of the reading device is from 0.02 m to 0.2 m.

The invention further relates to a method of identifying one or more blanks in a machining device, according to which a memory which is attached to the blank is read by means of a reading device on the machining device by way of radio signals, and the radio signal is checked before the machining process is enabled. The data can thus be used for accounting in a usage-based accounting system.

It is advantageous when the memory, before insertion thereof into a chuck of the machining device, is activated by a radio signal, particularly by writing thereon by means of a handheld writing device. This activation process ensures that the information in the memory has been checked and that the blank that is about to be machined is the one intended.

The memory is activated by means of the read-write device. This is located inside the machining device in the proximity of the clamped blank. Alternatively, a separate handheld appliance located outside the machining device can be used for activation.

It is also conceivable that, after the machining process starts, the movement of the memory can be sensed, ensuring that the blank being machined is the one intended. This can be done by measuring the change of signal strength, for example. When a blank rotates, the signal strength oscillates in correlation with the frequency of rotation. In this way, unambiguous identification of the blank is made possible.

Another option is not to start the machining process until predefined initial conditions are achieved, such as a certain temperature.

It is advantageous when, following the successful checking of the radio signal, information is read out from the memory, and the machining process proceeds on the basis of said information, since this procedure ensures that blank-specific information is taken into account accordingly.

Furthermore, it is advantageous when the radio signal is checked with reference to its strength, or in the case of multiple signals, with reference to the highest signal strength. With this approach, there is no harm in multiple memories of different blanks responding to one reading device. The correct blank will still be read with respect to the information stored in the memory.

It may be advantageous for the memory to be activated when the blank is inserted into the machining device without any further manual intervention being necessary, thus avoiding the risk of the blank being put aside after the memory has been read and the wrong blank being set up as a result.

It is advantageous when the memory is read continuously during the machining process so that continuous control is possible. For instance sensor signals indicating the temperature can be read on a continuous basis.

It is advantageous when the blank, after it has been machined, is barred from the same machining process or the memory is destroyed by the machining device. This again ensures that additional machining is no longer possible.

### BRIEF DESCRIPTION OF THE DRAWINGS

An exemplifying embodiment of the invention is shown in the drawings, in which:

FIGS. 1A to 1D show several embodiments of a blank of the invention having a readable memory;

FIGS. 2A to 2B show several embodiments of a readable memory;

FIG. 3 shows a diagrammatic construction of machining device of the invention having a measuring means of the invention, and a computer connected thereto;

FIG. 4 is a detail of the machining device in the region of the machining chamber with a reading device for a blank held in a chuck, and

FIG. 5 shows a machining device containing a blank to be machined.

### DETAILED DESCRIPTION OF EXEMPLARY EMBODIMENTS OF THE INVENTION

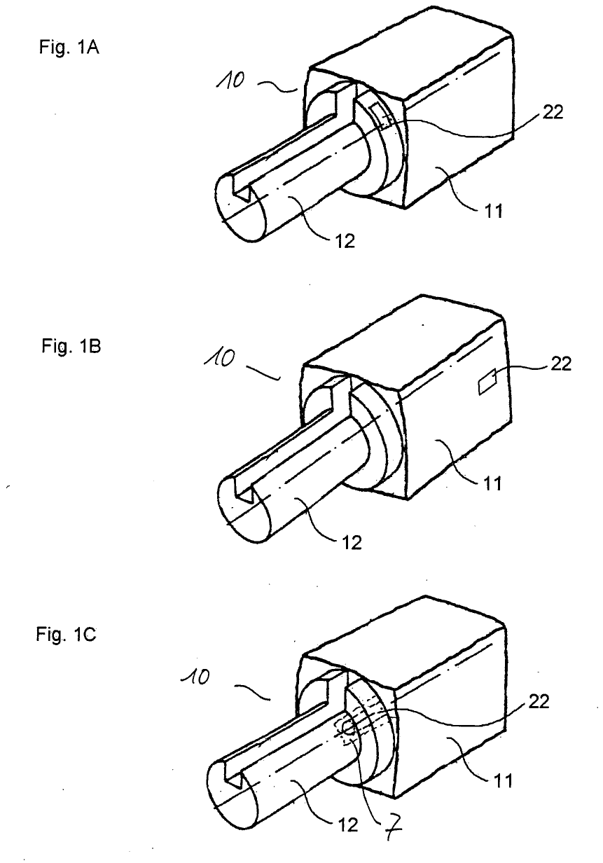

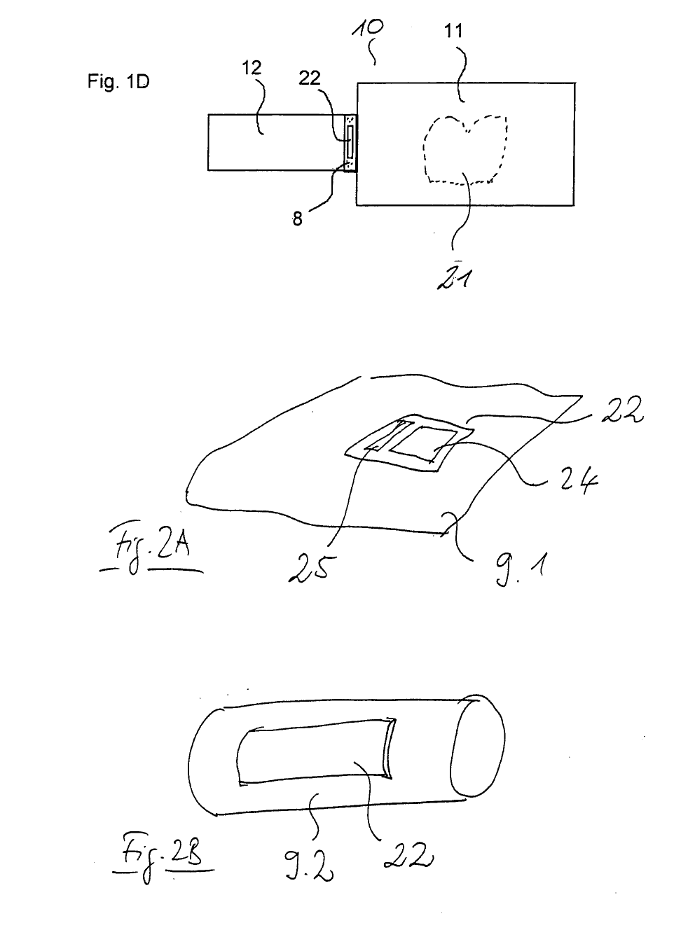

The blank 10 of the invention which is represented in FIGS. 1A to 1D comprises a blank corpus 11 and a stub 12. The size and shape of the blank corpus 11 are chosen such that a required dental prosthetic item 21 to be machined can be carved therefrom. The blank 10 further comprises a memory 22 which contains material-specific information and other information.

The memory 22 can be read by the use of radio signals, and the information can be converted to processible data by means of software. With memories of this kind, known as RFID, it is possible, unlike in the case of conventional barcodes, to store extensive information in a small space due to a high information density. Furthermore, these memories need not be attached to a visible surface of the marked object for the purpose of being optically read, but rather, they can be read from a distance of several meters at any time.

The RFID chip can be integrated into the blank in the following way, for example:

According to FIG. 1A, the RFID chip is attached to the stub 12 in the form of a self-adhesive label, for example a plastic strip. According to FIG. 1B, the RFID chip is placed on the blank corpus 11. According to FIG. 1C, the RFID chip is enclosed in a glass tube and disposed in a cavity 7 of the stub 12. The cavity 7 can be a recess in the shaft or disk-shaped portion of the stub. According to FIG. 1D the RFID chip is embedded in an adhesive layer 8 between the stub 12 and the blank corpus 11, for instance while enclosed in a glass tube. The material of the stub 12 can be a metal or a plastics material. If the memory is built in according to FIG. 1C, plastics material is preferred because metal shields the signals.

As illustrated in FIG. 2A, the memory 22 can be part of a self-adhesive label 9.1 or as illustrated in FIG. 2B, can be enclosed in a glass tube 9.2.

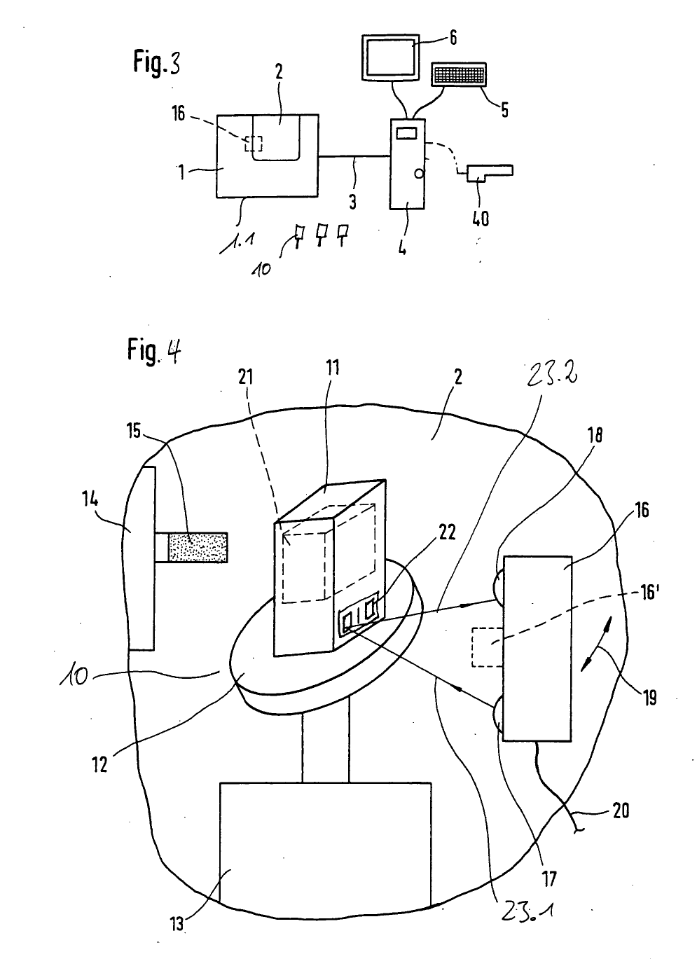

FIG. 3 shows a machining device 1 comprising a machining chamber 2, which is connected to a computer (PC) 4 via a cable 3. The computer can alternatively be integrated into the machine housing 1.1. The PC 4 is provided with input means in the form of a keyboard 5 and output means in the form of a monitor 6. Data needed for the operation of the machining device 1 can be transmitted through the line 3.

Machining of one or more blanks 10 takes place in the machining chamber 2, and a reading device 16 is provided for reading the memory on the blank 10 to be machined.

If reading does not occur in the machining chamber 2, a reading device 40 can be provided which is connected to the computer and which serves to read the memory before the blank is inserted into the machining device.

FIG. 4 illustrates a subregion of the machining chamber 2 in detail. It shows a blank in the form of a blank 10 to be machined, as known from dental ceramics technology, which has a corpus 11 fixed to a stub 12, which is clamped in a chuck 13.

At least one tool 14 is also located in the machining chamber 2, such as a grinding pin, which is a machining tool 15 and which removes material when pressed against the blank corpus 11.

A reading device 16 is provided in the machining chamber 2. The reading device 16 comprises a transmitter 17, which emits a radio signal 23.1, and a receiver 18, in which a radio signal 23.2 emitted by the memory 22 is received.

Radio signals detected by the reading device 16 are transmitted through a cable 20 to the machining apparatus and, optionally after being preprocessed, thence to the computer through a cable 3 (FIG. 3). By this means the information present in the memory 22 is evaluated by the software running on computer 4.

The procedure followed in connection with the use of machining device 1 of the invention will now described. On the basis of a data set of a dental prosthetic item to be produced, the user selects a blank 10 from which to carve the dental prosthetic item 22.

The blank 10 may be of a material that can be subjected to thermal treatment following the machining process. One possible material is an incompletely sintered ceramics material. This material changes shape predictably during the thermal treatment, though the particular properties of the material depend on how it is produced and therefore may differ from one batch to the other. In this case the machining process is followed by a sintering process in which the dental prosthetic item acquires greater strength. However, shrinkage occurs during such thermal sintering treatment.

It is therefore necessary to take into account the dimensional change due to shrinkage when designing the shaped body to be machined. This dental prosthetic item must be produced with oversize dimensions so that the subsequent shrinkage will give the required final dimensions.

To that end, information is read from the memory located on the blank via radio signals. The data set relating to the dental prosthetic item to be produced is adapted by software with reference to material-specific information in the memory 22 so that an edited data set is used for the production of the dental prosthetic item. Besides shrinkage parameters, the memory 22 can also contain data relating to the hardness of the material, the type of material used, grain size, block size, block shape, color, layering, alignment, serial number, manufacturer, or other identifying features of the individual piece, among other information.

From this information, the machining speed, the tool to be used, minimum wall thicknesses, and other important parameters can be determined and allowed for by the software when generating the edited data set.

The blank 10 provided with the memory 22 is spatially oriented in relation to the reading device 16 such that the reading device will collect the radio signals delivered by the memory 22. The typical range of the reading device is from 2 to 20 cm with an angle of departure of more than 60°. It is advantageous when the reading device is disposed close to the memory, for instance on the tool spindle 14.

The memory can be read before commencement of and/or throughout the machining process. On completion of the machining operation, the information in the memory can be changed by writing to the memory.

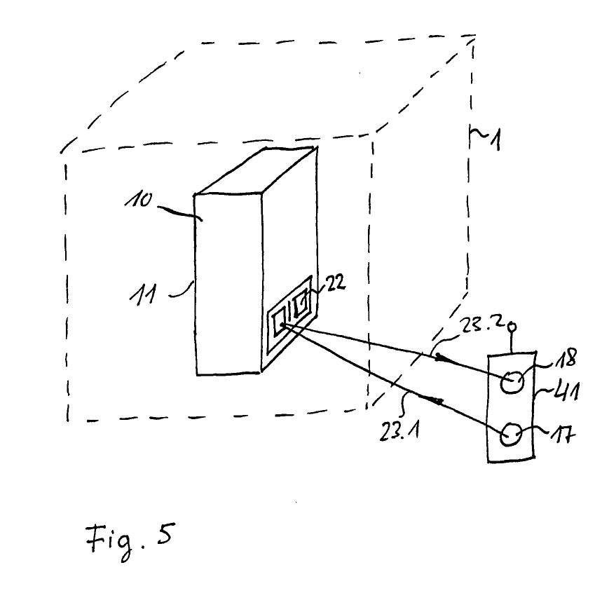

FIG. 5 illustrates a machining device 1 containing the blank 10 to be machined. The memory 22 is placed on the blank corpus 11. A handheld read/writing device 41 located outside the machining device comprises a transmitter 17 which emits a radio signal 23.1, and a receiver 18 in which a radio signal 23.2 emitted by the memory 22 is received. By means of the handheld read/writing device 41 the memory 22 can be activated from outside the machining device 1.

1. A blank (10) for the production of a dental prosthetic item (21) by machining said blank (10), which blank (10) is provided with information relevant to said machining, wherein a readable memory (22) containing said information is connected to said blank (10) is provided, said memory (22) being designed and disposed on said blank (10) in such a manner that said information can be read via radio signals (23).

2. A blank as defined in claim 1, wherein the information stored in said memory (22) can be modified by radio signals (23).

3. A blank as defined in claim 1, wherein a stub (12) for attachment of said blank in a machining device (1) is provided and said memory (22) is attached to said stub (12).

4. A blank as defined in claim 1, wherein a corpus (11) is provided, from which said dental prosthetic item (21) is carved, and said memory (22) is attached to said corpus (11).

5. A blank as defined in claim 1, wherein a stub (12) for the attachment of said blank in said machining device (1) and a corpus (11), from which said dental prosthetic item (21) is carved, are provided, and said memory (22) is disposed in a connecting layer (8) provided between said corpus (11) and said stub (12).

6. A blank as defined in claim 1, wherein a stub (12) for the attachment of said blank in said machining device (1) is provided and said memory (22) is incorporated in said stub (12), which stub (12) is at least partially permeably to radio signals.

7. A blank as defined in claim 1, wherein said memory (22) is enclosed in a glass tube (9.2) or in a self-adhesive label (9.1).

8. A blank as defined in claim 1, wherein an information bit present in said memory (22) is a signal value of a sensor (25) disposed in the immediate vicinity of said memory (22), which signal value is capable of being queried via said memory (22) by means of a radio signal.

9. A machining device (1) for the production of dental prosthetic items from a blank (10), comprising a chuck (13) for accommodating said blank (10), information concerning said blank (10) being present on said blank (10), wherein a reading device (16) is provided for reading an information-containing memory (22) by means of radio signals (23).

10. A machining device (1) as defined in claim 9, wherein said reading device (16) additionally has a write function for the purpose of modifying information present in said memory (22) via radio signals.

11. A machining device (1) as defined in claim 9, wherein software for the production of said dental prosthetic item (21) is provided and said software is designed such that the information obtained via radio signals (23) is allowed for in the computation of said dental prosthetic item (21) to be fabricated and/or in the control of said machining device (1) and/or in any other type of processing of said dental prosthetic item (21) and/or in the use thereof for documentation purposes.

12. A machining device (1) as defined in claim 9, wherein said reading device (16) is disposed in relation to said chuck (13) such that the information concerning said blank (10) held in said chuck (13) provides the strongest radio signal in relation to blanks (10) not held in said chuck (13).

13. A machining device (1) as defined in claim 9, wherein the distance of said reading device (16) from said chuck (13) is smaller than the distance of said blank (10) to an external housing (1.1) of said machining device (1).

14. A machining device (1) as defined in claim 9, wherein the range of the reading device (16) is from 0.02 m to 0.2 m.

15. A method for recognizing one or more blanks in a machining device, wherein a memory (22) placed on said blank (10) is read via a radio signal (23.1) before or after the insertion of said blank into a chuck (13), in particular by writing thereon with a handheld read/write device (41).

16. A method as defined in claim 15, wherein said memory (22) is activated before reading.

17. A method as defined in claim 15, wherein said memory (22) is read by means of a reading device (16) on the machining device (1) via radio signal (23.1) and radio signal (23.2) emitted by said memory (22) is checked before machining is enabled.

18. A method as defined in claim 17, wherein, following successful checking of said radio signal (23.2), information is read out from said memory (22) and the machining operation takes place while making allowances for said information.

19. A method as defined in claim 15, wherein checking of the radio signal (23.2) is carried out on the basis of the strength of said radio signal (23.2), and, in the case of more than one radio signal, use is made of that radio signal having the greatest signal intensity.

20. A method as defined in claim 15, wherein said memory (22) is activated when said blank (10) is inserted into said machining device (1).

21. A method as defined in claim 15, wherein said memory (22) is continuously read during machining.

22. A method as defined in claim 15, wherein said memory (22) is written to, following machining, such that said blank (10) is barred from further machining or that said memory (22) is destroyed by a machining tool (15).

23. A method as defined in claim 15, wherein said memory (22) is written to, following machining, such that its condition is known for future machining.
